(19) United States
(12) Patent Application Publication
(10) Pub. No.: US 2025/0352004 A1
(43) Pub. Date: Nov. 20, 2025

(54) RINSE RACK SINK MAT

(71) Applicant: Ginsey Industries, Inc., Swedesboro, NJ (US)

(72) Inventor: Chris Greco, Swedesboro, NJ (US)

(21) Appl. No.: 19/208,880

(22) Filed: May 15, 2025

Related U.S. Application Data
(60) Provisional application No. 63/647,896, filed on May 15, 2024.

(51) Int. Cl. A47J 47/20

(52) U.S. Cl. CPC A47J 47/20

(57) ABSTRACT

The present disclosure pertains to a sink mat configured for insertion within a sink basin, comprising a base formed of a rigid, planar material, the base having a top surface and a bottom surface; and at least one center fold line oriented across the width of the base, defining at least one bisecting crease to allow the mat to be folded into a V-shape for ease of debris disposal and storage.

### CROSS REFERENCE TO RELATED APPLICATIONS

This application claims priority to U.S. Provisional Patent Application Ser. No. 63/647,896, filed on May 15, 2024, entitled RINSE RACK SINK MAT, which is hereby incorporated by reference in its entirety.

### FIELD

The present disclosure pertains to the field of kitchen accessories, specifically sink inserts designed to facilitate dishwashing, drying, and waste management through improved drainage and organization within a sink.

### BACKGROUND

Traditional sink mats are commonly employed to protect dishware from damage and to aid in the drying process by elevating items above the base of the sink. However, these sink mats frequently fall short in several areas. Traditional designs often do not adequately facilitate water drainage, leading to stagnant water accumulation which can contribute to the growth of mold and bacteria, thereby posing hygiene concerns. Additionally, traditional sink mats are not designed to accommodate the varying configurations of sink basins and drains, which can result in poor alignment with the sink's drain. Furthermore, traditional sink mats lack the ability to accommodate the varying shapes and sizes of dishes. Kitchenware, tableware, and other associated items come in various forms, from plates and bowls to oversized utensils and irregularly shaped items. Traditional sink mats struggle to secure these items effectively, which may lead to unstable positioning and potential damage.

The limitations in adaptability and the inefficiency in drainage and hygiene maintenance are significant issues that remain unaddressed by traditional sink mats. There is, therefore, a need for a sink mat that not only improves upon these deficiencies by providing superior drainage and antimicrobial characteristics but also offers customization to fit a variety of sink designs and improved accessibility, thereby enhancing the overall utility of the sink space.

### SUMMARY

In some embodiments, the present invention comprises a sink mat configured for insertion within a sink basin. In some embodiments, the mat comprises a base formed of a rigid, planar material, the base having a top surface and a bottom surface. In some embodiments, the mat comprises at least one center fold line oriented across the width of the base, defining at least one bisecting crease to allow the mat to be folded into a V-shape for ease of debris disposal and storage.

In some embodiments, the base comprises an irregular octagonal shape such that the corners of an otherwise rectangular shape are truncated, resulting in a geometric shape that combines four larger sides and four shorter, beveled sides at each corner.

In some embodiments, the base is surrounded by a surrounding edge contour that extends vertically above the top surface of the base.

In some embodiments, the base forms therethrough a plurality of apertures to facilitate draining. In some embodiments, the plurality of apertures are individually diamond shaped. In some embodiments, the plurality of apertures are arranged linearly in staggered rows.

In some embodiments, the sink mat further comprises elevated dividers extending vertically from the top surface of the base, traversing the mat in a direction parallel to the center fold line. In some embodiments, the elevated dividers have a cantilevered design that provides an overhang that supports dishes in an inclined position, facilitating an inclined position for organization and drying. In some embodiments, the base forms therethrough a plurality of apertures adjacent to the elevated dividers on the base to facilitate drainage. In some embodiments, the elevated dividers are varied in width to accommodate a diverse range of dish and utensil sizes.

In some embodiments, the sink mat further comprises a plurality of feet vertically extending from the bottom surface and configured to provide stability and maintain the base in a raised position relative to the sink's surface to enable under-mat drainage. In some embodiments, the feet are configured in a multifaceted arrangement comprising a staggered pattern around the outer perimeter of the base, a set of parallel zig-zag lines perpendicular to the at least one center fold line, and in straight lines parallel to the at least one center fold line located near the outer longitudinal ends of the base. In some embodiments, the feet extend to the same height below the mat, ensuring the mat remains flat even when unfolded and placed in a sink. In some embodiments, the feet are configured as a semi-circular protrusion having a curved edge contour to reduce surface contact with the sink.

In some embodiments, the sink mat further comprises elevated end contours that curve upwardly and outwardly from the longitudinal ends of the rectangular base such that a user can slide their hands under the contours to grab and fold the base.

In some embodiments, the bottom surface of the base further comprises a scored drain cut-out template comprising pre-scored, weakened lines designed for selective removal by the user. In some embodiments, the scored drain cut-out template includes multiple removable sections to accommodate different sink drain sizes and positions. In some embodiments, the sink mat further comprises a drain hole aligned with the sink drain, the drain hole created by user-modification of the scored drain cut-out template.

In some embodiments, the mat comprises one or more materials comprising antimicrobial properties. In some embodiments, the antimicrobial material is selected from a group consisting of an antimicrobial thermoplastic elastomer (TPE) and silicone.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIGS. 1A-1B depict perspective views of the sink mat from an upper perspective view and a lower perspective view, respectively, according to embodiments of the present disclosure.

FIGS. 2A-2B depict a top view and a bottom view, respectively, of the sink mat 100, according to embodiments of the present disclosure.

FIGS. 3A-3C depict side views of the sink mat 100 according to embodiments of the present disclosure.

FIG. 4 depicts the sink mat shown in a folded state along the center fold line, according to an embodiment of the present disclosure.

FIG. 5 depicts an enlarged perspective view of the bottom surface of the sink mat, according to an embodiment of the present disclosure.

FIG. 6 depicts the sink mat displayed in use within a kitchen sink, according to an embodiment of the present disclosure.

### DETAILED DESCRIPTION

The present disclosure pertains to a sink mat designed to enhance the functionality of kitchen sinks by providing an organized surface for dishwashing while promoting efficient drainage and waste disposal. In some embodiments, the sink mat is characterized by a base with a top surface and a bottom surface. The top surface is the principal area where dishes and utensils rest. The base comprises a plurality of drainage apertures that allow water and fine particles to pass into the sink's drainage system while preventing the passage of larger debris, thus preventing clogs.

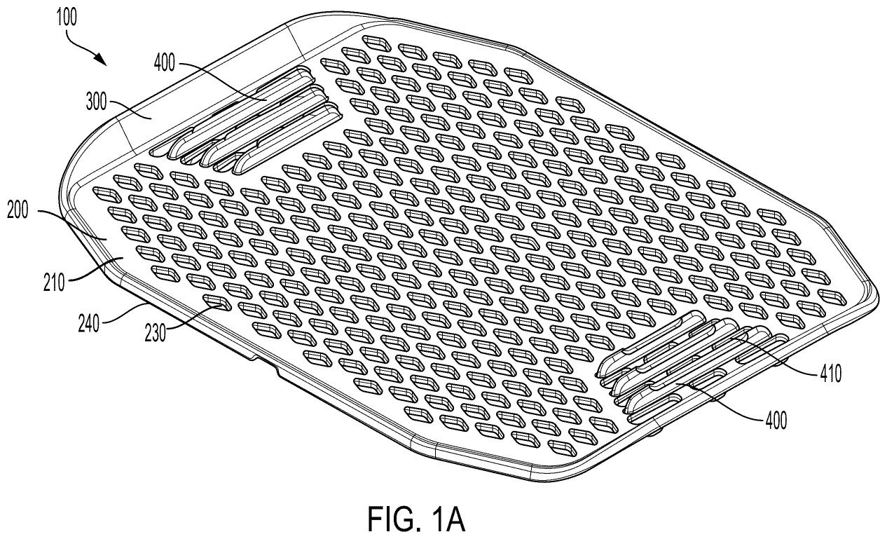

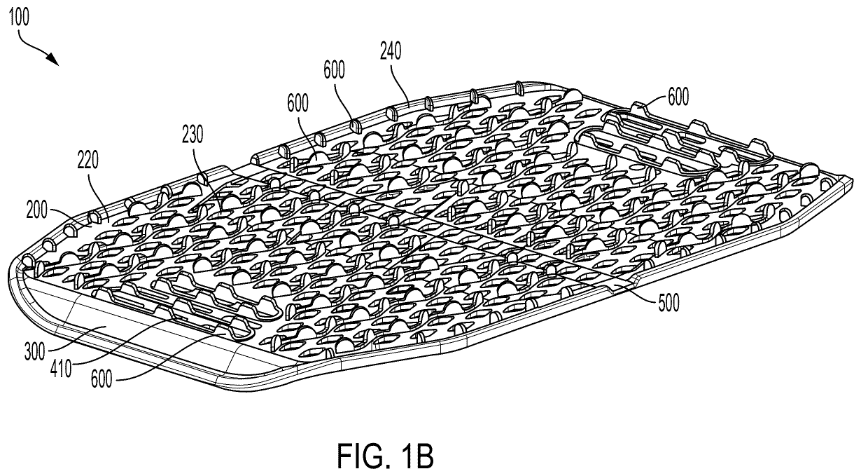

Turning now to the figures, FIGS. 1A-1B depict perspective views of a sink mat 100, according to embodiments of the present disclosure.

In some embodiments, as depicted in FIGS. 1A-1B, the sink mat 100 has a base 200 with a top surface 210, shown in FIG. 1A, and a bottom surface 220, shown in FIG. 1B. In some embodiments, the base 200 is perforated by a plurality of drainage apertures 230 arrayed to permit the passage of water and fine particles into the sink's drainage system. These drainage apertures 230 are sized to retain large debris on top of the mat 100, thereby preventing clogging of the sink's drainage system.

In some embodiments, as depicted in FIGS. 1A-1B, surrounding the periphery of the base 200 of the mat 100 is a surrounding edge contour 240, a slightly elevated boundary. As depicted in FIG. 1A, the surrounding edge contour 240 may be elevated above the top surface 210 of the base 200; this configuration helps to confine water within the base 200, directing it towards the drainage apertures 230.

In some embodiments, as depicted in FIGS. 1A-1B, the sink mat 100 comprises elevated end contours 300 along the two longitudinal ends of the mat 100, providing leverage points for user interaction, particularly when engaging the central folding mechanism.

In some embodiments, the mat 100 further comprises at least one center fold line 500, which is at least one crease or hinge-like feature that bisects the mat 100. This at least one center fold line 500 allows the mat 100 to be folded in a V-shape, or in half, thereby aiding in the ability to remove debris from the sink and/or compactly store or manipulate the mat 100.

In some embodiments, the sink mat 100 further comprises elevated dividers 400, which are ridges or barriers that extend vertically from the top surface 210 of the base 200. These dividers 400 serve as organizational partitions for dishes, allowing the user to lean dishes against them, thereby reducing clutter within the sink basin.

In some embodiments, as depicted in FIG. 1B, elevated feet 600 extend from the bottom surface 220 of the base 200 and are distributed across the bottom surface of the mat's base 200. The feet 600 elevate the mat 100, ensuring a space between the sink base and the mat 100 for unobstructed water flow and debris passage to the sink drain. The feet 600 also lend stability to the mat 100, preventing its adherence to the sink surface when damp and securing the mat's 100 position within the sink.

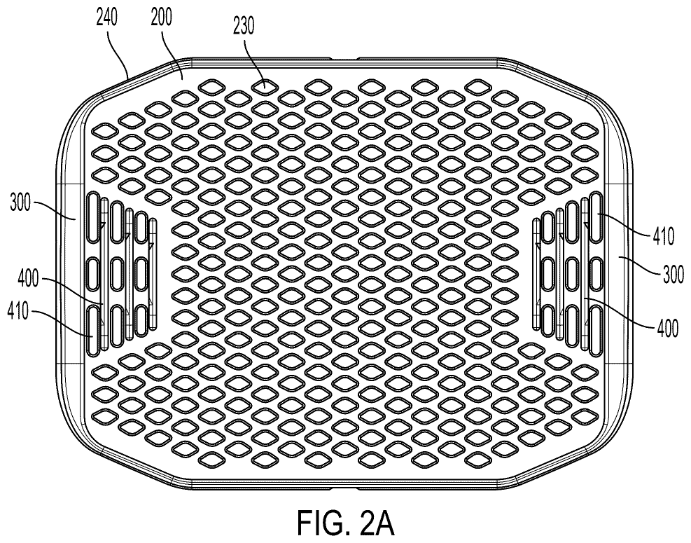

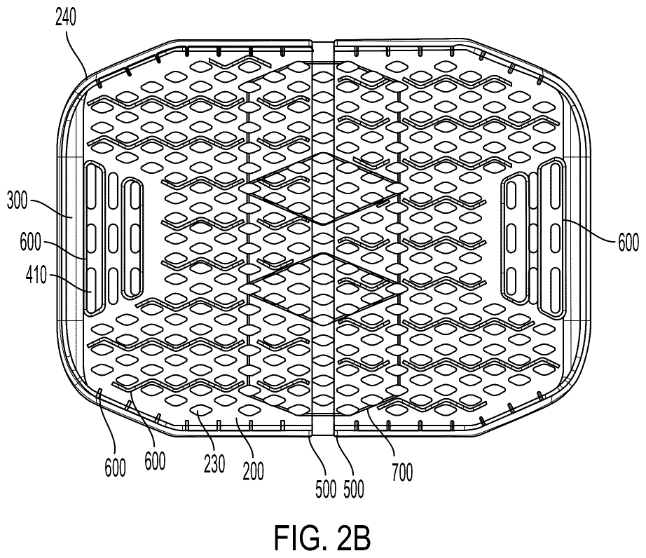

In some embodiments, as depicted FIGS. 2A-2B, the sink mat 100 is shaped to fit within the confines of a sink basin. In some embodiments, the sink mat 100 has an irregular octagonal shape. The corners of an otherwise rectangular base are truncated, resulting in a geometric shape that combines four larger sides—representative of the rectangle's edges—and four shorter, beveled sides at the rectangle's corners. In some embodiments, these truncated corners are rounded, softening the overall outline. However, the subject matter disclosed herein is not so limited. Instead, the sink mat can be any shape, including, for example, rectangular and circular.

In some embodiments, as depicted in FIGS. 1A-1B and FIGS. 2A-2B, a surrounding edge contour 240 surrounds the perimeter of the base 200. In some embodiments, the surrounding edge contour 240 may vertically extend from the top surface 210 of the base 200; this configuration helps to confine water within the base 200, directing it towards the drainage apertures 230.

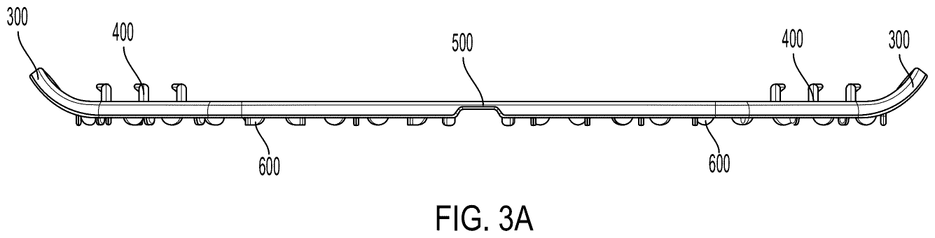

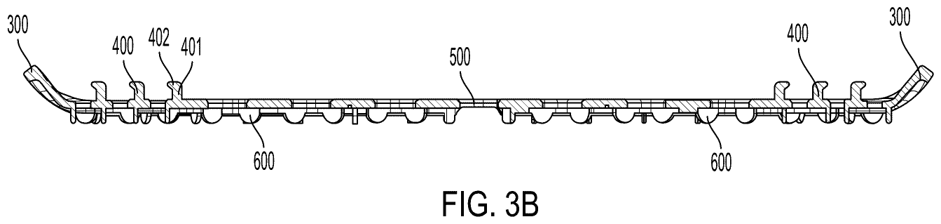

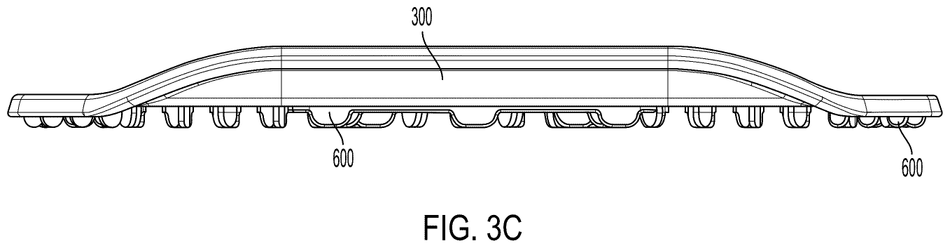

In some embodiments, as depicted in FIGS. 1A-1B, FIGS. 2A-2B, and FIGS. 3A-3C, elevated end contours 300 are present along the two opposing longitudinal ends of the sink mat 100. These end contours 300 serve as barriers to contain water and provide leverage points for the user. These end contours 300 assist in the easy manipulation of the mat 100, whether for folding, lifting, or repositioning the mat 100 within the sink basin. In some embodiments, elevated end contours 300 extend outwards from the two longitudinal ends of the mat 100, beyond the surrounding edge contour 240. In some embodiments, the end contours 300 extend to a height above the base 200 and above the surrounding edge contour 240, creating distinct elevated points for easy grabbing. In some embodiments, as depicted in FIG. 3A, the elevated end contour 300 curves up and away from the base 200. In some embodiments, as depicted in FIG. 2A and FIG. 3C, the elevated end contour 300 is less wide than the width of the mat at its longitudinal center.

In some embodiments, as depicted in FIG. 1A, FIG. 2A, and FIGS. 3A-3B, the sink mat 100 further comprises elevated dividers 400, which are ridges or barriers that extend vertically from the top surface 210 of the base 200. They offer organizational benefits, creating sections that allow for the upright positioning of dishes. This organization aids in increasing the available space within the sink and expedites the drying process. In some embodiments, the elevated dividers 400 may extend from the top surface 210 of the base 200, within the surrounding edge contour 240, and closer to the left and right ends of the mat. In some embodiments, the elevated dividers 400 may run linearly, parallel to each other, and parallel to the center fold line 500.

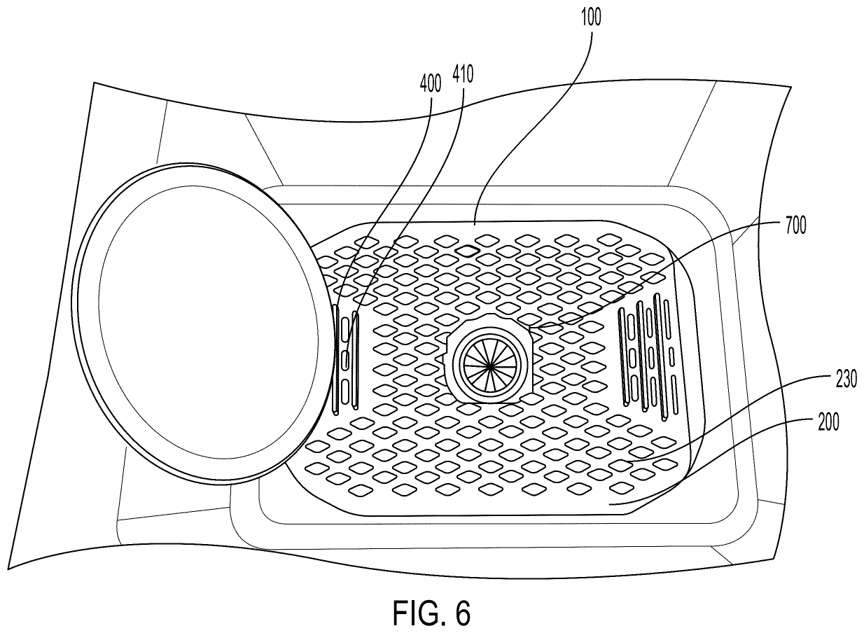

In some embodiments, as depicted in FIGS. 3A-3B, the elevated dividers 400 are structurally characterized by a cantilevered design. More specifically, the elevated dividers 400 comprise a post 401 that extends vertically from the top surface 210 of the base 200 and a ridge 402 that protrudes horizontally from the top of the post 401. The ridge 402 provides an overhang that supports dishes in an inclined position, facilitating an inclined position for organization and drying, as depicted in FIG. 6. Additionally, the ridge 402 may function as a counterbalance for dishes placed against it, preventing them from tipping over due to their weight.

In some embodiments, as depicted in FIG. 1A and FIG. 2B, the elevated dividers 400 are varied in width to accommodate a diverse range of dish and utensil sizes.

In some embodiments, as depicted in FIGS. 1A-2B, the base 200 of the mat 100 is characterized by a series of drainage apertures 230. In some embodiments, these drainage apertures 230 are individually diamond shaped. In some embodiments, the drainage apertures 230 are collectively organized in staggered rows that span the base's 200 surface. This configuration can not only improve water flow for efficient drainage, but also may not sacrifice the base's 200 structural integrity, thereby ensuring the base 200 can support the weight of dishes and utensils. The uniform distribution of the drainage apertures 230 also provides a balanced support for kitchen items placed on the mat 100, which may prevent tipping and sliding, thereby enhancing the safety and stability of dishware during dishwashing.

In some embodiments, the base 200 of the mat 100 is further characterized by a series of divider drainage apertures 410, which are openings adjacent to the elevated dividers 400 that help avoid water from stagnating around items propped on the elevated dividers 400. In some embodiments, as depicted in FIGS. 2A-2B, there may be multiple divider drainage apertures 410 next to the elevated dividers 400. The divider drainage apertures 410 may also provide an area to support dishes, as depicted in FIG. 6. A dish can be placed in the divider drainage apertures 410 and against an elevated divider 400, with both elements serving to support the dish in an elevated position.

In some embodiments, as depicted in FIG. 2B, elevated feet 600 are arrayed in multiple patterns on the bottom surface 220 of the mat's base 200. In some embodiments, the feet 600 may be distributed around the outer perimeter of the mat 100 in a staggered formation adjacent to the surrounding edge contour 240. In some embodiments, there are a set of staggered feet 600 aligned in parallel zig-zag lines across the width of the mat's base 200, perpendicular to the center fold line 500. These zig-zag lines of feet 600 reinforce the mat's structure and provide resilience against the weight of dishes and utensils, ensuring that the mat maintains its shape and functionality over time. In some embodiments, there are a set of feet 600 parallel to the center fold line 500 and near the divider drainage apertures 410; these feet 600 are staggered and in straight lines, providing additional support and stability to these areas. In some embodiments, the feet 600 are aligned to correspond with the drainage apertures 230, ensuring that the drainage of water is not impeded when the mat 100 is placed flat in the sink. In FIG. 2B, the drainage apertures 230 are visible from the bottom perspective, revealing their functional design which complements the elevated feet 600.

In some embodiments, as depicted in FIGS. 3A-3C, all the feet 600 extend to the same height below the mat, ensuring the mat remains flat even when unfolded and placed in a sink.

In some embodiment, as depicted in FIG. 2B, the sink mat 100 may comprise a locking mechanism facilitated by the asymmetric configuration of the elevated feet. In some embodiments, there are a set of feet 600 parallel to the center fold line 500 and near the divider drainage apertures 410. In some embodiments, these feet 600 may form a border or multiple borders around the drainage apertures 410. In some embodiments, on one side of the mat, the feet 600 may form a border with a marginally larger enclosure as compared to the other side. This difference in the enclosure size allows the feet on one side to interlock within the corresponding feet on the other side. This interlocking feature allows the mat 100 to lock when folded on the back side.

In some embodiments, as depicted in FIG. 1B and FIGS. 3A-3C, the feet are comprised of a series of spaced apart semi-circular protrusions with a convex curvature facing downward. This geometry allows for reduced contact with the sink basin while providing adequate support and stability for the mat.

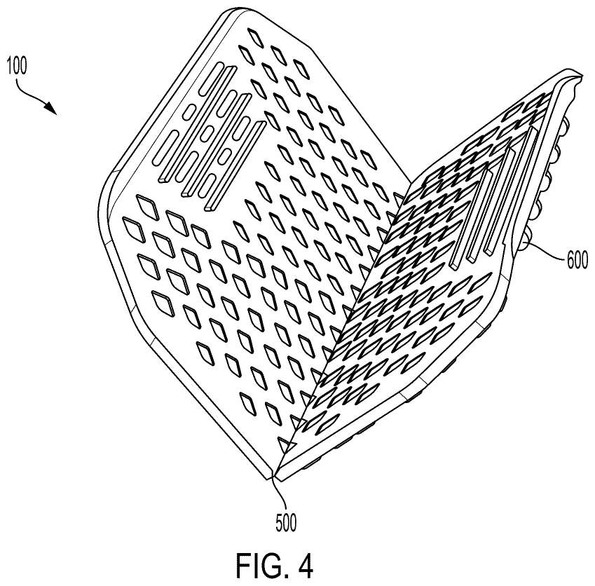

In some embodiments, as depicted in FIG. 1B, FIG. 2B, FIGS. 3A-3B, and FIG. 4, the mat further comprises at least one center fold line 500. The center fold line 500 is at least one crease or hinge that bisects the center of the sink mat 100 longitudinally. This hinge-like feature allows the mat 100 to be folded in half in a V-shape. Such a fold is useful for compact storage and for the user to conveniently dispose of accumulated debris.

FIG. 4 depicts the sink mat 100 shown in a folded state along the center fold line 500, according to an embodiment of the present disclosure. In some embodiments, as depicted in FIG. 4, the mat 100 can be folded upwards along the center fold line 500 to form a V-shape. The folding action is enabled by the at least one center fold line 500. When folded, the elevated feet 600 become the outermost points of the mat 100. Folding allows for the disposal of waste from the mat's 100 surface. When not in use, the foldable design also aids in the storage of the sink mat 100, allowing it to be stored away more compactly.

The depiction of the single center fold line 500 in FIG. 4 contrasts with the dual fold lines 500 shown in FIG. 2B. In some embodiments, there are two center fold lines 500. In some embodiments, there is one center fold line 500. The choice between a single or dual fold line design may be influenced by a balance of functionality, user convenience, and spatial efficiency. The dual fold lines offer compactness in storage, as the mat can be folded into a smaller form factor, which is advantageous in environments where space is crucial. Furthermore, the dual fold lines may allow for a stable, self-supporting structure when the mat is positioned upright, a feature that can be beneficial for drying or storage. Conversely, the single fold line design offers a streamlined experience with simple folding and unfolding actions. Additionally, the single fold line design may be conducive to the mat's structural integrity over time. Moreover, the V-shape formed by the single fold line facilitates efficient central disposal of waste, directing debris and liquids towards a singular point for easy cleaning.

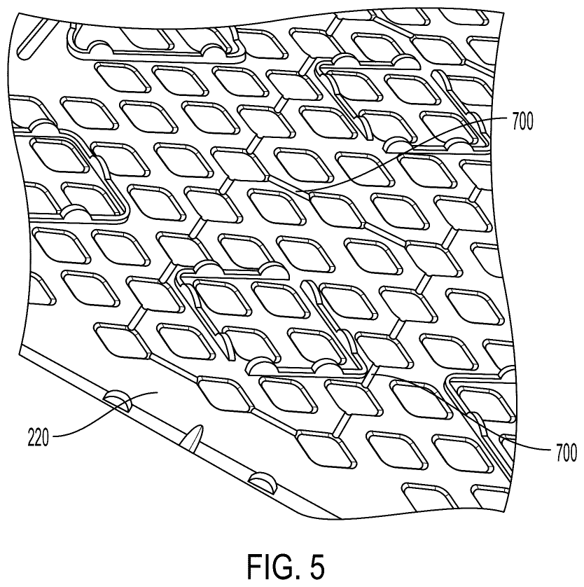

In some embodiments, as depicted in FIG. 2B and FIG. 5, the mat 100 comprises a customizable drain cut-out template 700, a pre-scored area on the bottom surface of the mat's base 200. This template 700 delineates, by weakened lines, removable sections of the base 200. The customizable drain cut-out template 700 is designed for user customization, allowing users to modify the base 200 to create an opening that precisely aligns with the specific configuration of their sink drain. Upon removal of material to form the opening, the structure in the area of the cut-out may no longer support functions such as the self-supporting stability discussed above.

In some embodiments, as depicted in FIG. 2B, the customizable drain cut-out template 700 is in the shape of an irregular octagon with elongated sides, positioned centrally around the mat's 100 center fold line 500. Within the octagon shape, there are additional cut lines forming diamond shapes. These cut lines and shapes indicate areas where the material can be removed by the user to create a drain opening. The design allows for a range of customization options, from a small opening to a larger shape. FIG. 5 depicts an enlarged perspective view of the bottom surface 220 of the sink mat 100, focusing on the customizable drain cut-out template 700, according to an embodiment of the present disclosure. In some embodiments, as depicted in FIG. 5, the customizable drain cut-out template 700 is in the shape of multiple small squares.

In some embodiments, as depicted in FIG. 3B, the apparatus may be a cohesive entity, crafted from a single material. In some embodiments, the apparatus may be at least two entities joined together at the center fold line 500. This unified construction may be desirable to achieve uniformity in material properties across the mat 100, providing consistent structural support, and antimicrobial protection.

In some embodiments, the mat 100 is made from antimicrobial materials. In some embodiments, the mat 100 is made from antimicrobial thermoplastic elastomer (TPE). In some embodiments, the mat 100 is made from silicone materials. The choice of an antimicrobial material inhibits the growth of bacteria and mold, ensuring that the mat 100 remains hygienic with reduced maintenance. The two materials presented above are examples and are not exhaustive.

In some embodiments, the mat is constructed from a pliable material, thus allowing for the creation of the center fold line and customizable drain cut-out template without compromising the structural integrity of the sink mat. The scored sections can be removed easily by the user to align with the sink drain, a process simplified by the material's ability to be cut without fraying or degrading.

FIG. 6 depicts the sink mat 100 within a kitchen sink, placed flat at the base of the sink, with a dish resting along an elevated divider 400, according to an embodiment of the present disclosure. The base 200 of the mat 100 and the drainage apertures 230 are visible in FIG. 6. The divider drainage apertures 410, as depicted in FIG. 6, are located near the elevated dividers 400. FIG. 6 further depicts the mat 100 positioned such that the opening created from the drain cut-out template 700 aligns with the sink's drain. This customizable aspect of the sink mat 100 underscores its adaptability to various sink shapes and designs, allowing users to modify the mat to fit around their specific needs.

### Example Use Case

The following example use case describes how an example of a sink mat according to the present disclosure may be used. This section is intended solely for explanatory purposes and not for limitation.

A user first places the sink mat flat at the base of the kitchen sink. In some embodiments, the mat's surrounding edge contour may fit comfortably within the sink basin or fit snugly against the sink's sides. In some embodiments, a cutting tool such as scissors or a knife may be employed to assist in cutting along the pre-scored lines. Regardless of the method employed, the removed sections are intended to come away cleanly.

The user can then use the customizable drain cut-out template as a guide to punch out the sections from the base to create an opening that fits around the sink drain. This process is straightforward, requiring no tools, and the removed sections come away cleanly due to the mat's material.

The user can begin washing dishes, setting them against the elevated dividers for drying after wash or for temporary storage as they continue with their cleaning tasks. Water flows freely through the drainage apertures, while larger food particles are caught, preventing the drain from clogging. The user can use the elevated dividers to organize plates by leaning the plates against the dividers. The nearby divider drainage apertures can prevent water from pooling around the plates. After the dishes are washed and dried, they can be removed from the mat, which can remain in place at the sink's base, ready to support the next round of dishwashing.

Once the washing is complete and all dishes have been moved off the mat, the user can lift the mat from the sink basin by grabbing the elevated end contours. The user can then fold the mat along the center fold line, forming a V-shape that funnels residual water and small debris towards the drain for easy disposal. Remaining larger debris can be held snuggly within the V-shape as the user carries the mat to a garbage can where the user may release the V-shape and let the debris fall into the garbage can. The fold lines are durable and withstand repeated use within showing signs of material fatigue.

Finally, when the cleaning is done, the user can rinse off the sink mat and fold it along the center fold line for compact storage under the sink. If the user prefers not to store the mat after each use, it can simply be unfolded and laid back at the base of the sink.

The elements of the figures are not exclusive. Other embodiments may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed.

We claim:

1. A sink mat configured for insertion within a sink basin, comprising:
a base formed of a rigid, planar material, the base having a top surface and a bottom surface; and
at least one center fold line oriented across the width of the base, defining at least one bisecting crease to allow the mat to be folded into a V-shape for ease of debris disposal and storage.

2. The sink mat of claim 1, wherein the base comprises an irregular octagonal shape such that the corners of an otherwise rectangular shape are truncated, resulting in a geometric shape that combines four larger sides and four shorter, beveled sides at each corner.

3. The sink mat of claim 1, wherein the base is surrounded by a surrounding edge contour that extends vertically above the top surface of the base.

4. The sink mat of claim 1, wherein the base forms therethrough a plurality of apertures to facilitate draining.

5. The sink mat of claim 4, wherein the plurality of apertures are individually diamond shaped.

6. The sink mat of claim 4, wherein the plurality of apertures are arranged linearly in staggered rows.

7. The sink mat of claim 1, further comprising elevated dividers extending vertically from the top surface of the base, traversing the mat in a direction parallel to the center fold line.

8. The sink mat of claim 7, wherein the elevated dividers have a cantilevered design that provides an overhang that supports dishes in an inclined position, facilitating an inclined position for organization and drying.

9. The sink mat of claim 7, wherein the base forms therethrough a plurality of apertures adjacent to the elevated dividers on the base to facilitate drainage.

10. The sink mat of claim 7, wherein the elevated dividers are varied in width to accommodate a diverse range of dish and utensil sizes.

11. The sink mat of claim 1, further comprising a plurality of feet vertically extending from the bottom surface and configured to provide stability and maintain the base in a raised position relative to the sink's surface to enable under-mat drainage.

12. The sink mat of claim 11, wherein the feet are configured in a multifaceted arrangement comprising a staggered pattern around the outer perimeter of the base, a set of parallel zig-zag lines perpendicular to the at least one center fold line, and in straight lines parallel to the at least one center fold line located near the outer longitudinal ends of the base.

13. The sink mat of claim 11, wherein the feet extend to the same height below the mat, ensuring the mat remains flat even when unfolded and placed in a sink.

14. The sink mat of claim 11, wherein the feet are configured as a semi-circular protrusion having a curved edge contour to reduce surface contact with the sink.

15. The sink mat of claim 1, further comprising elevated end contours that curve upwardly and outwardly from the longitudinal ends of the rectangular base such that a user can slide their hands under the contours to grab and fold the base.

16. The sink mat of claim 1, wherein the bottom surface of the base further comprises a scored drain cut-out template comprising pre-scored, weakened lines designed for selective removal by the user.

17. The sink mat of claim 16, wherein the scored drain cut-out template includes multiple removable sections to accommodate different sink drain sizes and positions.

18. The sink mat of claim 16, further comprising a drain hole aligned with the sink drain, the drain hole created by user-modification of the scored drain cut-out template.

19. The sink mat of claim 1, wherein the mat comprises one or more materials comprising antimicrobial properties.

20. The sink mat of claim 19, wherein the antimicrobial material is selected from a group consisting of an antimicrobial thermoplastic elastomer (TPE) and silicone.
